(19) United States
(12) Patent Application Publication
(10) Pub. No.: US 2017/0004123 A1
(43) Pub. Date: Jan. 5, 2017

(54) INTERACTIVE GUI REVIEW TOOL SYSTEM AND METHOD

(71) Applicant: International Business Machines Corporation, Armonk, NY (US)

(72) Inventors: Denise A. Bell, Austin, TX (US); Lisa Seacat DeLuca, Baltimore, MD (US); David J. Levinson, Marietta, GA (US); Randa Salem, Rome (IT)

(21) Appl. No.: 14/754,839

(22) Filed: Jun. 30, 2015

(51) Int. Cl. G06F 17/24; G06F 3/0482

(52) U.S. Cl. CPC G06F 17/241; G06F 3/0482

(57) ABSTRACT

A method, computer program product, and computer system for generating an overlay layer on a user interface. Annotation of the user interface may be enabled via the overlay layer associated with a defect. A screenshot of the overlay layer on the user interface may be captured, wherein the screenshot, when an annotation is present, may include the annotation. Information associated with the screenshot may be transferred to a code tracking tool to display a change request for the defect.

### BACKGROUND

In development environments (e.g., software development), the process of identifying, tagging and tracking user interface (UI) defects may be a cumbersome process. For example, user experience (UX) and design experts may identify problem areas when doing reviews or usability tests on the UI. Generally, once a problem is identified, it is up to the individuals to, e.g., track the location and task sequence where the problem is identified, and define the UI issues where the problem is identified. Then, the individuals have to go into code tracking tools, open defects and recreate the scenario, UI position and issues.

### BRIEF SUMMARY OF DISCLOSURE

In one example implementation, a method, performed by one or more computing devices, may include but is not limited to generating, by a computing device, an overlay layer on a user interface. Annotation of the user interface may be enabled via the overlay layer associated with a defect. A screenshot of the overlay layer on the user interface may be captured, wherein the screenshot, when an annotation is present, may include the annotation. Information associated with the screenshot may be transferred to a code tracking tool to display a change request for the defect.

One or more of the following example features may be included. Build information of the user interface may be queried to obtain at least a portion of the information associated with the screenshot, wherein the screenshot may include the build information. The build information may include a version number of the user interface. A plurality of selectable options to include with the screenshot may be displayed. At least one of the plurality of selectable options may include task flow information. The annotation may include at least one of a comment and a markup. The annotation may be added as a DOM element to the screenshot.

In another example implementation, a computing system includes a processor and a memory configured to perform operations that may include but are not limited to generating an overlay layer on a user interface. Annotation of the user interface may be enabled via the overlay layer associated with a defect. A screenshot of the overlay layer on the user interface may be captured, wherein the screenshot, when an annotation is present, may include the annotation. Information associated with the screenshot may be transferred to a code tracking tool to display a change request for the defect.

One or more of the following example features may be included. Build information of the user interface may be queried to obtain at least a portion of the information associated with the screenshot, wherein the screenshot may include the build information. The build information may include a version number of the user interface. A plurality of selectable options to include with the screenshot may be displayed. At least one of the plurality of selectable options may include task flow information. The annotation may include at least one of a comment and a markup. The annotation may be added as a DOM element to the screenshot.

In another example implementation, a computer program product resides on a computer readable storage medium that has a plurality of instructions stored on it. When executed by a processor, the instructions cause the processor to perform operations that may include but are not limited to generating an overlay layer on a user interface. Annotation of the user interface may be enabled via the overlay layer associated with a defect. A screenshot of the overlay layer on the user interface may be captured, wherein the screenshot, when an annotation is present, may include the annotation. Information associated with the screenshot may be transferred to a code tracking tool to display a change request for the defect.

One or more of the following example features may be included. Build information of the user interface may be queried to obtain at least a portion of the information associated with the screenshot, wherein the screenshot may include the build information. The build information may include a version number of the user interface. A plurality of selectable options to include with the screenshot may be displayed. At least one of the plurality of selectable options may include task flow information. The annotation may include at least one of a comment and a markup. The annotation may be added as a DOM element to the screenshot.

The details of one or more example implementations are set forth in the accompanying drawings and the description below. Other possible example features and/or possible example advantages will become apparent from the description, the drawings, and the claims. Some implementations may not have those possible example features and/or possible example advantages, and such possible example features and/or possible example advantages may not necessarily be required of some implementations.

### BRIEF DESCRIPTION OF THE DRAWINGS

FIG. 1 is an example diagrammatic view of a review process coupled to a distributed computing network according to one or more example implementations of the disclosure;

FIG. 2 is an example diagrammatic view of a client electronic device of FIG. 1 according to one or more example implementations of the disclosure;

FIG. 3 is an example flowchart of the review process of FIG. 1 according to one or more example implementations of the disclosure;

FIG. 4 is an example diagrammatic view of a screen image displayed by the review process of FIG. 1 according to one or more example implementations of the disclosure; and

FIG. 5 is an example diagrammatic view of a screen image displayed by the review process of FIG. 1 according to one or more example implementations of the disclosure.

Like reference symbols in the various drawings indicate like elements.

### DETAILED DESCRIPTION

### System Overview

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

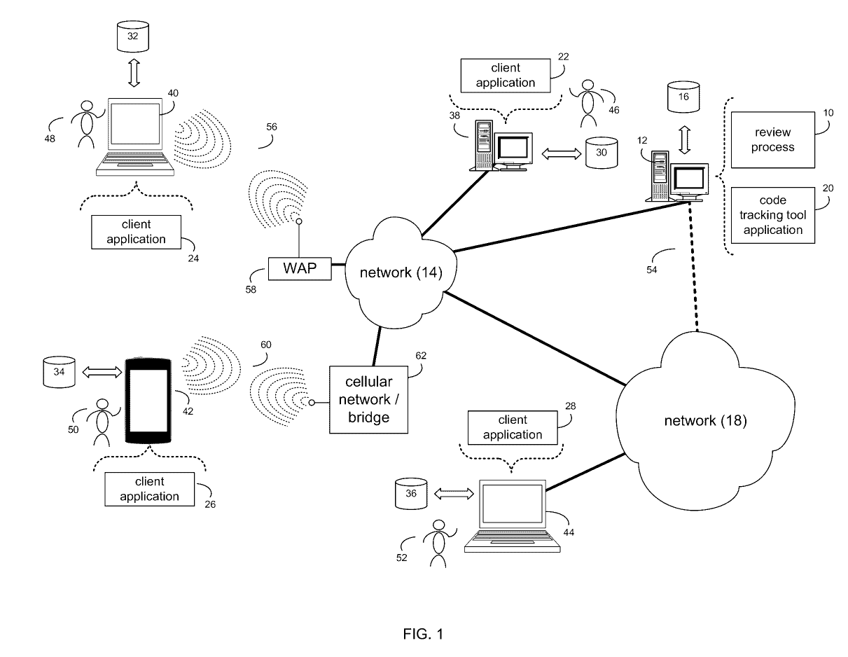

Referring now to FIG. 1, there is shown review process 10 that may reside on and may be executed by a computer (e.g., computer 12), which may be connected to a network (e.g., network 14) (e.g., the internet or a local area network). Examples of computer 12 (and/or one or more of the client electronic devices noted below) may include, but are not limited to, a personal computer(s), a laptop computer(s), mobile computing device(s), a server computer, a series of server computers, a mainframe computer(s), or a computing cloud(s). Computer 12 may execute an operating system, for example, but not limited to, Microsoft® Windows®; Mac® OS X®; Red Hat® Linux®, or a custom operating system. (Microsoft and Windows are registered trademarks of Microsoft Corporation in the United States, other countries or both; Mac and OS X are registered trademarks of Apple Inc. in the United States, other countries or both; Red Hat is a registered trademark of Red Hat Corporation in the United States, other countries or both; and Linux is a registered trademark of Linus Torvalds in the United States, other countries or both).

As will be discussed below in greater detail, review process 10 may generate, by a computing device, an overlay layer on a user interface. Annotation of the user interface may be enabled via the overlay layer associated with a defect. A screenshot of the overlay layer on the user interface may be captured, wherein the screenshot, when an annotation is present, may include the annotation. Information associated with the screenshot may be transferred to a code tracking tool to display a change request for the defect.

The instruction sets and subroutines of review process 10, which may be stored on storage device 16 coupled to computer 12, may be executed by one or more processors (not shown) and one or more memory architectures (not shown) included within computer 12. Storage device 16 may include but is not limited to: a hard disk drive; a flash drive, a tape drive; an optical drive; a RAID array; a random access memory (RAM); and a read-only memory (ROM).

Network 14 may be connected to one or more secondary networks (e.g., network 18), examples of which may include but are not limited to: a local area network; a wide area network; or an intranet, for example.

Computer 12 may include a data store, such as a database (e.g., relational database, object-oriented database, triplestore database, etc.) and may be located within any suitable memory location, such as storage device 16 coupled to computer 12. Any data described throughout the present disclosure may be stored in the data store. In some implementations, computer 12 may utilize a database management system such as, but not limited to, “My Structured Query Language” (MySQL®) in order to provide multi-user access to one or more databases, such as the above noted relational database. The data store may also be a custom database, such as, for example, a flat file database or an XML database. Any other form(s) of a data storage structure and/or organization may also be used. Review process 10 may be a component of the data store, a stand alone application that interfaces with the above noted data store and/or an applet/application that is accessed via client applications 22, 24, 26, 28. The above noted data store may be, in whole or in part, distributed in a cloud computing topology. In this way, computer 12 and storage device 16 may refer to multiple devices, which may also be distributed throughout the network.

Computer 12 may execute a code tracking tool application (e.g., code tracking tool application 20), examples of which may include, but are not limited to, e.g., an agile planning application, a process definition application, a source control application, a code tracking application, a build management application, a reporting application, or other application that allows for virtual meeting and/or remote collaboration or other application that allows for authoring, collaboration, and administration tools used to create and manage content (e.g., user interface content). Examples of code tracking tool application 20 may include, e.g., Rational Team Concert (RTC), Configuration Management Version Control (CMVC), etc. Review process 10 and/or code tracking tool application 20 may be accessed via client applications 22, 24, 26, 28. Review process 10 may be a stand alone application, or may be an applet/application/script/extension that may interact with and/or be executed within code tracking tool application 20, a component of code tracking tool application 20, and/or one or more of client applications 22, 24, 26, 28. Code tracking tool application 20 may be a stand alone application, or may be an applet/application/script/extension that may interact with and/or be executed within review process 10, a component of review process 10, and/or one or more of client applications 22, 24, 26, 28. One or more of client applications 22, 24, 26, 28 may be a stand alone application, or may be an applet/application/script/extension that may interact with and/or be executed within and/or be a component of review process 10 and/or code tracking tool application 20. Examples of client applications 22, 24, 26, 28 may include, but are not limited to, e.g., an agile planning application, a process definition application, a source control application, a code tracking application, a build management application, a reporting application, or other application that allows for virtual meeting and/or remote collaboration or other application that allows for authoring, collaboration, and administration tools used to create and manage content (e.g., user interface content), a standard and/or mobile web browser, an email client application, a textual and/or a graphical user interface, a customized web browser, a plugin, an Application Programming Interface (API), or a custom application. The instruction sets and subroutines of client applications 22, 24, 26, 28, which may be stored on storage devices 30, 32, 34, 36, coupled to client electronic devices 38, 40, 42, 44, may be executed by one or more processors (not shown) and one or more memory architectures (not shown) incorporated into client electronic devices 38, 40, 42, 44.

Storage devices 30, 32, 34, 36, may include but are not limited to: hard disk drives; flash drives, tape drives; optical drives; RAID arrays; random access memories (RAM); and read-only memories (ROM). Examples of client electronic devices 38, 40, 42, 44 (and/or computer 12) may include, but are not limited to, a personal computer (e.g., client electronic device 38), a laptop computer (e.g., client electronic device 40), a smart/data-enabled, cellular phone (e.g., client electronic device 42), a notebook computer (e.g., client electronic device 44), a tablet (not shown), a server (not shown), a television (not shown), a smart television (not shown), a media (e.g., video, photo, etc.) capturing device (not shown), and a dedicated network device (not shown). Client electronic devices 38, 40, 42, 44 may each execute an operating system, examples of which may include but are not limited to, Android′, Apple® iOS®, Mac® OS X®; Red Hat® Linux®, or a custom operating system.

One or more of client applications 22, 24, 26, 28 may be configured to effectuate some or all of the functionality of review process 10 (and vice versa). Accordingly, review process 10 may be a purely server-side application, a purely client-side application, or a hybrid server-side/client-side application that is cooperatively executed by one or more of client applications 22, 24, 26, 28 and/or review process 10.

One or more of client applications 22, 24, 26, 28 may be configured to effectuate some or all of the functionality of code tracking tool application 20 (and vice versa). Accordingly, code tracking tool application 20 may be a purely server-side application, a purely client-side application, or a hybrid server-side/client-side application that is cooperatively executed by one or more of client applications 22, 24, 26, 28 and/or code tracking tool application 20. As one or more of client applications 22, 24, 26, 28, review process 10, and code tracking tool application 20, taken singly or in any combination, may effectuate some or all of the same functionality, any description of effectuating such functionality via one or more of client applications 22, 24, 26, 28, review process 10, code tracking tool application 20, or combination thereof, and any described interaction(s) between one or more of client applications 22, 24, 26, 28, review process 10, code tracking tool application 20, or combination thereof to effectuate such functionality, should be taken as an example only and not to limit the scope of the disclosure.

Users 46, 48, 50, 52 may access computer 12 and review process 10 (e.g., using one or more of client electronic devices 38, 40, 42, 44) directly through network 14 or through secondary network 18. Further, computer 12 may be connected to network 14 through secondary network 18, as illustrated with phantom link line 54. Review process 10 may include one or more user interfaces, such as browsers and textual or graphical user interfaces, through which users 46, 48, 50, 52 may access review process 10.

The various client electronic devices may be directly or indirectly coupled to network 14 (or network 18). For example, client electronic device 38 is shown directly coupled to network 14 via a hardwired network connection. Further, client electronic device 44 is shown directly coupled to network 18 via a hardwired network connection. Client electronic device 40 is shown wirelessly coupled to network 14 via wireless communication channel 56 established between client electronic device 40 and wireless access point (i.e., WAP) 58, which is shown directly coupled to network 14. WAP 58 may be, for example, an IEEE 802.11a, 802.11b, 802.11g, Wi-Fi®, and/or Bluetooth™ (including Bluetooth™ Low Energy) device that is capable of establishing wireless communication channel 56 between client electronic device 40 and WAP 58. Client electronic device 42 is shown wirelessly coupled to network 14 via wireless communication channel 60 established between client electronic device 42 and cellular network/bridge 62, which is shown directly coupled to network 14.

Some or all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. Bluetooth™ (including Bluetooth™ Low Energy) is a telecommunications industry specification that allows, e.g., mobile phones, computers, smart phones, and other electronic devices to be interconnected using a short-range wireless connection. Other forms of interconnection (e.g., Near Field Communication (NFC)) may also be used.

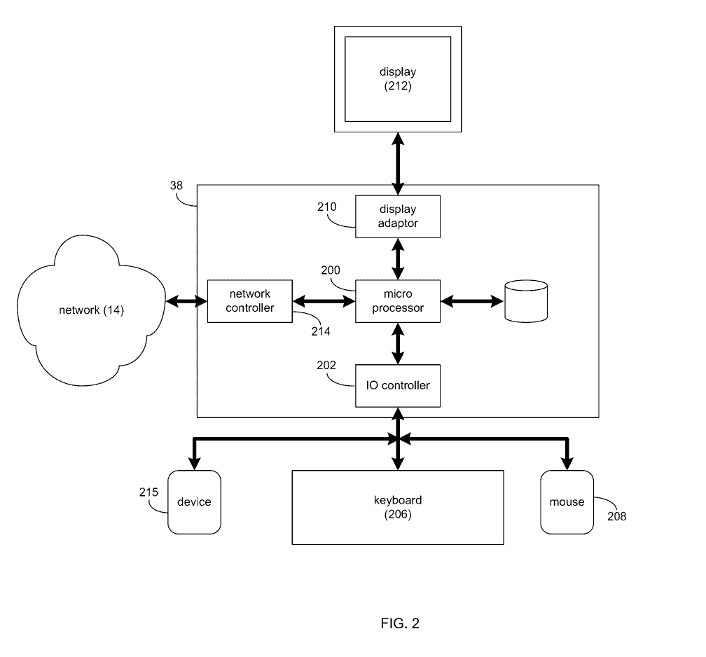

Referring also to FIG. 2, there is shown a diagrammatic view of client electronic device 38. While client electronic device 38 is shown in this figure, this is for illustrative purposes only and is not intended to be a limitation of this disclosure, as other configurations are possible. For example, any computing device capable of executing, in whole or in part, review process 10 may be substituted for client electronic device 38 within FIG. 2, examples of which may include but are not limited to computer 12 and/or client electronic devices 40, 42, 44.

Client electronic device 38 may include a processor and/or microprocessor (e.g., microprocessor 200) configured to, e.g., process data and execute the above-noted code/instruction sets and subroutines. Microprocessor 200 may be coupled via a storage adaptor (not shown) to the above-noted storage device(s) (e.g., storage device 30). An I/O controller (e.g., I/O controller 202) may be configured to couple microprocessor 200 with various devices, such as keyboard 206, pointing/selecting device (e.g., mouse 208), custom device (e.g., device 215), USB ports (not shown), and printer ports (not shown). A display adaptor (e.g., display adaptor 210) may be configured to couple display 212 (e.g., CRT or LCD monitor(s)) with microprocessor 200, while network controller/adaptor 214 (e.g., an Ethernet adaptor) may be configured to couple microprocessor 200 to the above-noted network 14 (e.g., the Internet or a local area network).

The Review Process:

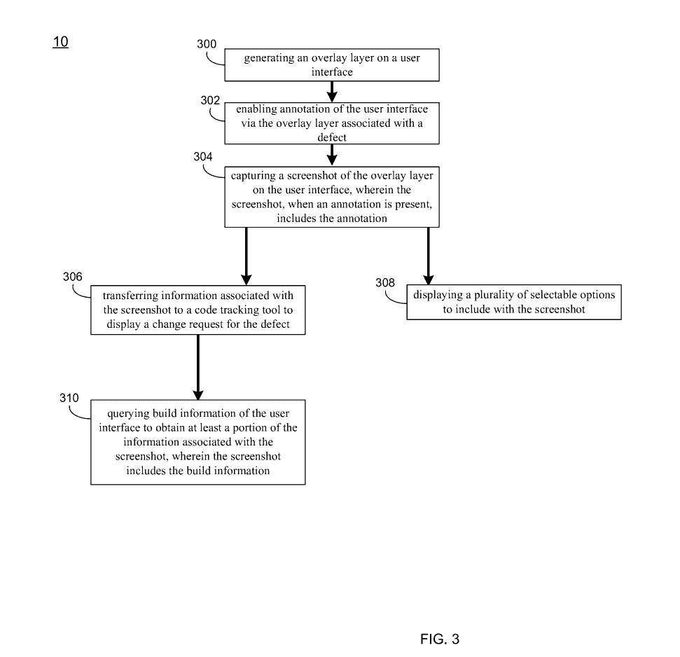

As discussed above and referring also at least to FIGS. 3-5, review process 10 may generate 300, by a computing device, an overlay layer on a user interface. Review process 10 may enable 302 annotation of the user interface via the overlay layer associated with a defect. A screenshot of the overlay layer on the user interface may be captured 304 by review process 10, wherein the screenshot, when an annotation is present, may include the annotation. Information associated with the screenshot may be transferred 306 by review process 10 to a code tracking tool to display a change request for the defect.

In development environments (e.g., software development), the process of identifying, tagging and tracking user interface (UI) defects may be a cumbersome process. User experience (UX) and design experts may identify problem areas when doing reviews or usability tests on the UI. Generally, once a problem is identified, it is up to the individuals to, e.g., capture screenshots of the UI where the problem is identified, track the location and task sequence, and define the UI issues. Then, the individuals have to go into code tracking tools (like RTC, CMVC, etc.), open defects and recreate the scenario, UI position and issues.

As will be discussed in greater detail below, review process 10 may enable reviewers to identify problem areas, capture a screenshot and task flow information, and transfer that information to the appropriate code (e.g., defect) management tool. This may streamline the UI review process and improve the contents available to explain the defect or issue. For example, while conducting UI reviews, design feedback sessions, usability testing, etc., the UX professional may have the ability to capture the context when they identify a problem.

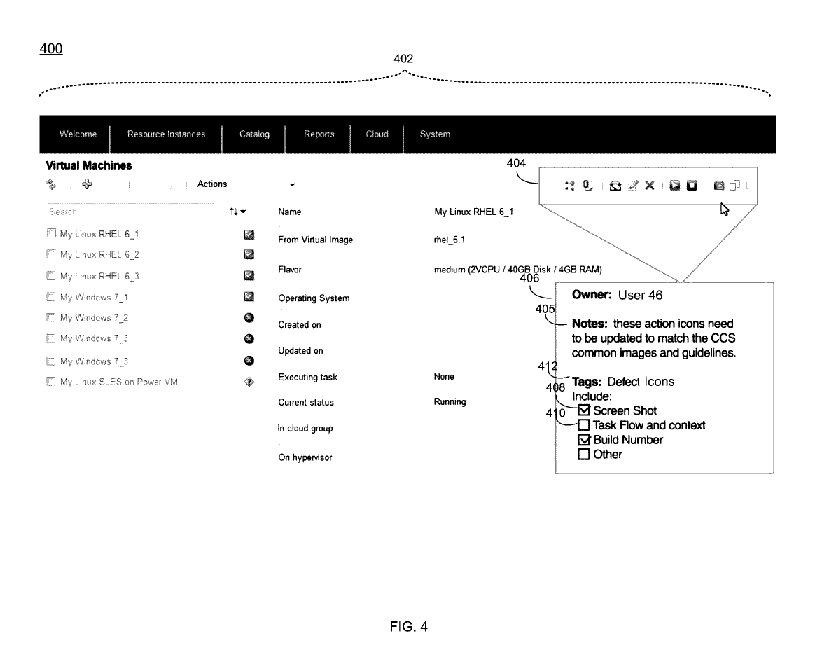

For instance, and referring at least to FIG. 4, assume for example purposes only that a reviewer (e.g., user 46) is in the process of reviewing a UI (e.g., UI 400). Review process 10 may generate 300, by a computing device, an overlay layer on a user interface. For example, review process 10 may generate 300 an overlay layer (e.g., overlay layer 402) using, e.g., HTML generated code. In some implementations, the overlay layer may replicate the display of the underlying UI view (e.g., UI 400), and may be presented by review process 10, for example, as a modal view on top of the underlying UI view. As will be discussed in greater detail below, the replicated overlay layer UI view may be enriched by review process 10 with the ability for the user to perform data entry actions, such as adding annotations like a comment and adding complementary information that may describe, e.g., UI review issues (or for any other desired purpose). Similarly, the replicated overlay layer UI view may also be enabled by review process 10 to allow the user to make other markup annotations, like marking up an area using a mouse or other annotation capable devices (e.g., a stylus pen). In some implementations, the overlay layer UI view may present the user with an action “button” or other object that may allow the capture of all the data/annotations entered by the user and perform additional actions related to storing the data/annotations entered by the user in relation to the overlay layer UI view.

In some implementations, review process 10 may enable 302 annotation of the user interface via the overlay layer associated with a defect. For example, the annotation may include at least one of a comment and a markup. For instance, assume for example purposes only that user 46 is reviewing UI 400, and determines there is a problem with the icons in the upper right corner of UI 400. Review process 10 may enable 302 user 46 to markup UI 400 (e.g., via overlay layer 402) by annotating with shapes (e.g., lines, boxes, such as box 404, triangles, arrows, etc.) or highlighting (e.g., with colors, various fonts, etc.) around the icons (or other portion of UI 400), thereby drawing attention to the problem area. In some implementations, review process 10 may enable 302 user 46 to comment on UI 400 (e.g., via overlay layer 402) by annotating with, e.g., a notes or comments section 405 of a dialogue box 406. In the example, the notes section in dialogue box 406 may enable (via review process 10) user 46 to describe in words what is the problem with the icons. It will be appreciated that other examples of visual suggestions for use during annotation may be used without departing from the scope of the disclosure.

In some implementations, review process 10 may enable 302 user 46 to enter tags on UI 400 (e.g., via overlay layer 402) by annotating with, e.g., tags section of a dialogue box 406. For example, tag section 412 may be used for user 46 (via review process 10) to enter one or more tags that may be used to reference multiple defects that may also include that tag. In the example, the tag “defect icons” may be used to reference multiple defects pertaining to icons.

In some implementations, a screenshot of the overlay layer on the user interface may be captured 304 by review process 10, wherein the screenshot, when an annotation is present, may include the annotation. For instance, and continuing with the above example, review process 10 may capture 304 a screenshot of overlay layer 402 on UI 400. In the example, the screenshot may be captured as an image file, and may include UI 400, overlay layer 402, and/or the markup/comment annotations made to overlay layer 402. In some implementations, the annotations may be added as a document object model (DOM) element to the screenshot. For example, the annotations may be added as DOM elements to the UI screen shot, indicating what areas correspond to the issues or comments identified (e.g., using html and Java code). As such, the image and graphic based tool portion of review process 10 may allow real-time interaction in a UI review process, providing mockup and annotation capabilities.

Additional information may be included in the screenshot. For example, in some implementations, review process 10 may display 308 a plurality of selectable options to include with the screenshot. For instance, review process 10 may display 308 options for user 46 to select (via review process 10) whether a screenshot is to be taken via screenshot option 408. In some implementations, at least one of the plurality of selectable options may include task flow information. For instance, review process 10 may display 308 options for user 46 to select (via review process 10) whether task flow information (e.g., what steps were taken to get to this point at UI 400) should be included when taking the screenshot via task flow and context option 410. In some implementations, review process 10 may create scripts to track the task flow, capturing user input, selection and the data being displayed, and may include this in the collection added to the defect.

In some implementations, information associated with the screenshot may be transferred 306 by review process 10 to a code tracking tool to display a change request for the defect. For example, the above-noted task flow and context information may be gathered, e.g., upon taking the screenshot. In some implementations, build information of the user interface may be queried 310 by review process 10 to obtain at least a portion of the information associated with the screenshot, wherein the screenshot may include the build information. For example, the build information may include a version number of the user interface. In some implementations, the build information may include other relevant code specifications. Some examples of code specifications in the build information may include, e.g., the version of the code and the specific date relative to that version of the code. In the example, these components (e.g., the annotations, task flow, build information, etc.) may be compiled and packaged together by response process 10 and attached to the related defects via overlay layer 402 and transferred to the appropriate code tracking tool (e.g., code tracking tool application 20).

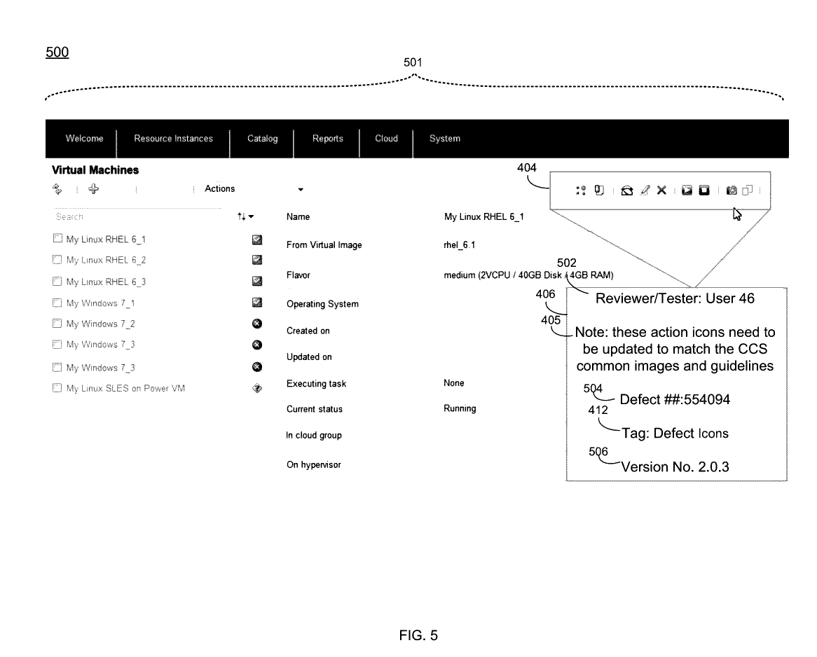

For instance, and referring at least to FIG. 5, an example visual display of the screenshot (e.g., screenshot 500) of UI 400 with the annotations of overlay layer 402 is shown in a change request 501. Change request 501 may be what is displayed by response process 10 (e.g., via code tracking tool application 20) when a user is implementing the changes noted by the reviewer. In the example, screenshot 500 includes the annotations 404 (e.g., added by response process 10 prior to the screenshot), reviewer/tester 502 who created the annotations (e.g., added by response process 10 prior to the screenshot), notes 405 (e.g., added by response process 10 prior to the screenshot), defect identification 504 (e.g., added by response process 10 after taking the screenshot), tag 412 (e.g., added by response process 10 prior to the screenshot), and version number 506 (e.g., added by response process 10 after taking the screenshot). It will be appreciated that other information may be added after taking the screenshot without departing from the scope of the disclosure. Thus, in the example, some information (e.g., annotations and markups) may be added via review process 10 to overlay layer 402 prior to capturing the screen to therefore include that information in the snapshot, whereas other information (e.g., build number and defect identification number) may be added to the screenshot after it is captured to therefore include that information in the snapshot. It will be appreciated that any of the information may be added prior to capturing the screenshot. For example, upon the creation of overlay layer 402, any appropriate information may be queried by review process 10 and added to, e.g., dialogue box 406 prior to capturing the screen to therefore include that information in the snapshot. As such, the addition of information before and/or after capturing the screenshot should be taken as example only and not to limit the scope of the disclosure.

In some implementations, review process 10 may be used as a component of automated testing (e.g., without requiring user review to discover a defect). For instance, review process 10 may be used to determine when deviations from the expected behaviors of the UI are detected. Once detected by response process 10, the above-noted relevant information (e.g., build information or other relevant code specifications) may be captured and included in the defect.

The terminology used herein is for the purpose of describing particular implementations only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps (not necessarily in a particular order), operations, elements, and/or components, but do not preclude the presence or addition of one or more other features, integers, steps (not necessarily in a particular order), operations, elements, components, and/or groups thereof.

The corresponding structures, materials, acts, and equivalents of all means or step plus function elements that may be in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications, variations, substitutions, and any combinations thereof will be apparent to those of ordinary skill in the art without departing from the scope and spirit of the disclosure. The implementation(s) were chosen and described in order to best explain the principles of the disclosure and the practical application, and to enable others of ordinary skill in the art to understand the disclosure for various implementation(s) with various modifications and/or any combinations of implementation(s) as are suited to the particular use contemplated.

Having thus described the disclosure of the present application in detail and by reference to implementation(s) thereof, it will be apparent that modifications, variations, and any combinations of implementation(s) (including any modifications, variations, substitutions, and combinations thereof) are possible without departing from the scope of the disclosure defined in the appended claims.

What is claimed is:

1. A computer-implemented method comprising:
generating, by a computing device, an overlay layer on a user interface;
enabling annotation of the user interface via the overlay layer associated with a defect;
capturing a screenshot of the overlay layer on the user interface, wherein the screenshot, when an annotation is present, includes the annotation; and
transferring information associated with the screenshot to a code tracking tool to display a change request for the defect.

2. The computer-implemented method of claim 1 further comprising querying build information of the user interface to obtain at least a portion of the information associated with the screenshot, wherein the screenshot includes the build information.

3. The computer-implemented method of claim 2 wherein the build information includes a version number of the user interface.

4. The computer-implemented method of claim 1 further comprising displaying a plurality of selectable options to include with the screenshot.

5. The computer-implemented method of claim 4 wherein at least one of the plurality of selectable options includes task flow information.

6. The computer-implemented method of claim 1 wherein the annotation includes at least one of a comment and a markup.

7. The computer-implemented method of claim 1 wherein the annotation is added as a DOM element to the screenshot.

8. A computer program product residing on a computer readable storage medium having a plurality of instructions stored thereon which, when executed by a processor, cause the processor to perform operations comprising:
generating an overlay layer on a user interface;
enabling annotation of the user interface via the overlay layer associated with a defect;
capturing a screenshot of the overlay layer on the user interface, wherein the screenshot, when an annotation is present, includes the annotation; and
transferring information associated with the screenshot to a code tracking tool to display a change request for the defect.

9. The computer program product of claim 8 further comprising querying build information of the user interface to obtain at least a portion of the information associated with the screenshot, wherein the screenshot includes the build information.

10. The computer program product of claim 9 wherein the build information includes a version number of the user interface.

11. The computer program product of claim 8 further comprising displaying a plurality of selectable options to include with the screenshot.

12. The computer program product of claim 11 wherein at least one of the plurality of selectable options includes task flow information.

13. The computer program product of claim 8 wherein the annotation includes at least one of a comment and a markup.

14. The computer program product of claim 8 wherein the annotation is added as a DOM element to the screenshot.

15. A computing system including a processor and a memory configured to perform operations comprising:
generating an overlay layer on a user interface;
enabling annotation of the user interface via the overlay layer associated with a defect;
capturing a screenshot of the overlay layer on the user interface, wherein the screenshot, when an annotation is present, includes the annotation; and
transferring information associated with the screenshot to a code tracking tool to display a change request for the defect.

16. The computing system of claim 15 further comprising querying build information of the user interface to obtain at least a portion of the information associated with the screenshot, wherein the screenshot includes the build information.

17. The computing system of claim 16 wherein the build information includes a version number of the user interface.

18. The computing system of claim 15 further comprising displaying a plurality of selectable options to include with the screenshot.

19. The computing system of claim 18 wherein at least one of the plurality of selectable options includes task flow information.

20. The computing system of claim 15 wherein the annotation includes at least one of a comment and a markup.
